(19) United States
(12) Patent Application Publication
(10) Pub. No.: US 2004/0197748 A1
(43) Pub. Date: Oct. 7, 2004

(54) Finger thinking educational tool

(76) Inventor: Robert H. Lamber, Morganville, NJ (US)

Correspondence Address: Charles I. Brodsky, Esq., 2 Bucks Lane, Marlboro, NJ, 07746, US

(21) Appl. No.: 10/731,389

(22) Filed: Dec. 10, 2003

Related U.S. Application Data
(60) Provisional application No. 60/433,569, filed on Dec. 16, 2002.

(51) Int. Cl. G09B 1/08

(52) U.S. Cl. 434/168

(57) ABSTRACT

A finger-tip encirclement worn on a finger of a user's hand when writing or studying to act as a placebo in recalling previously learned educational materials by having a surface positioned thereon to be rubbed between at least two fingers of the hand during the act of information retrieval.

### CROSS-REFERENCE TO RELATED APPLICATIONS

A provisional application describing this invention was filed Dec. 16, 2002 and assigned Serial No. 60/433,569.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

### FIELD OF THE INVENTION

This invention relates to educational tools which encourage cognitive thinking and memory tasks, in general, and to an educational tool providing a combined visual and physical stimulus as a triggering mechanism to enhance the focus and concentration of school-age children, in particular.

### SUMMARY OF THE INVENTION

As is known and understood, placebo results are well documented in medical research. Scientific studies have shown that placebos have psychological effects on humans which produce positive physical responses not otherwise attributable to any active medication then being tested. Being verified in countless research studies, placebos are used and understood today as being a significant control statistic in clinical medical trials.

There, given an objective way of comparing what one could expect from an active medicine, the placebo gives a way of indicating what one could expect from a non-active or psychological behavioral response. Numerous studies show that these placebos stimulate subconscious physical reactions brought about by “words of encouragement” or “positive suggestions”. In medical clinical trials, for example, once it becomes clear as to which study-patients actually receive the placebo and not the active medication, it has been found that the placebo group showed an unbelievable 15-30% symptomatic relief not accountable to the active medicine. Conclusions have followed that such positive behavioral improvements are caused by physical changes clearly associated with psychological beliefs—commonly viewed as “mind over matter”. As will become clear hereinafter, the present invention follows this recognition that if placebos can create positive changes in human behavior in medical trials, they can produce positive behavioral changes when employed in the educational field as well.

As will be readily appreciated by educators, a specially designed placebo, if introduced properly, could be utilized for tremendous advances in learning. Analysis indicates that if a 15-30% psychological response to a placebo is available in medical testing, then it should be equally as available to stimulate increased learning in memory tasks in child study. Biofeedback research techniques offer the analysis that educational improvements can be had in these manners in like way.

In carrying out the teachings of the present invention, emphasis is based on those numerous studies that show that when medical patients are placed in a double blind study, where random groups are given either an active medication or a placebo medication—which typically contains no active medication whatsoever—, the group with the placebo medication shows this 15-30% positive result in its effect against the disorder being investigated. As no medical reason has been able to explain the positive results, theories abound that it is the patient's own psychological belief that the medicine he/she is receiving helps the situation, in creating a biological change which creates these positive results. Such positive improvement has been demonstrated in many other activities where encouragement through positive thinking has been employed.

As will be seen from the description below, this combining of a visual and physical stimulus—as with placebo medication—provides a triggering mechanism to help focus and concentration in studying.

Having its sole purpose to increase one's natural inborn ability to learn, memorize, recall information, and think with greater cognition (and, thus, producing a better learning experience, especially in school-age children), the finger thinking educational tool of the invention comprises an encirclement worn on a finger-tip of a user's hand when writing or studying, having a surface positioned thereon to be rubbed between at least two fingers of the hand in recalling educational material previously learned. Denominated as FINGERTHINKERS, these educational tools may be worn on one of the index, middle, ring and little fingers of the hand, to then be rubbed by the thumb; or, alternatively, may be worn on the thumb of the hand, to be rubbed by the index, middle, ring or little finger. Composed of a durable soft fabric, the finger-tip encirclement preferably may be of a flexible fabric as well, so as to be placeable on the finger simply by a pinching of its opposite sides. A leather-like fabric is especially useful in this regard, of a natural or brown coloration.

In accordance with the invention, the surface to be rubbed includes a discernible point of attention focus. This point preferably is to be smooth to a tapping or rotational touch of the fingers and may include a magnetic insert. Such insert, affording a small screen appearance of black surfacing has proven particularly useful—and all that is required is that it be inserted facing inwardly towards the palm of the user's hand, preferably of minimal strength. When placed over an index finger, for example, the surface of the magnet would be oriented to face toward the palm for the thumb to come in contact with it simply by tapping the thumb and magnet together, or by rotating the thumb along the magnet. Such rotation keeps the thumb and magnet in contact—although a repeated pinching motion could be had where the thumb moves on and off the magnetic surface.

In use, cognitive learning and memory enhancement follows when wearing the FINGERTHINKERS educational tool in manner such that when one needs to focus on any particular subject (e.g., studying, classroom activities, taking a test, general creative thinking, etc.), the user simply places the finger thinking tool over the index finger (for example), touches the magnet surface with the face of the thumb, and rotates the thumb. The physical process—like with the placebo medication—unconsciously works, making the user pay more attention to what is to be focused on, in learning the information. When the need to recall the information arises, the finger thinking tool could be placed back onto the finger once again, the side of the user's temple touched lightly, and the recollection of what had previously been memorized then returns. The finger thinking educational tool provides the psychological results analogous to the placebo effects in then disciplining one's thoughts in focusing.

### BRIEF DESCRIPTION OF THE DRAWINGS

These and other features of the present invention will be more clearly understood from a consideration of the following description, taken in connection with the accompanying Drawings, in which:

FIGS. 1A and 1B are front and rear views of a finger thinking educational tool constructed in accordance with a preferred embodiment of the invention; and

FIGS. 2-4 are views helpful in an understanding of a manner of employing the finger thinking tool in accordance with the teachings herein.

### DETAILED DESCRIPTION OF THE INVENTION

As will be appreciated, one of the most exciting aspects of the finger thinking educational tool of the invention is the fun that it adds to the process of thinking, turning learning into a fun experience. Employing the basic techniques of placebo effects and biofeedback, the FINGERTHINKERS educational tool works through a combination of five (5) physical and psychological elements:

a) Making learning fun;

b) The power of suggestion;

c) The sensory association of visual and physical stimulus;

d) The individual's desire to succeed; and

e) The uniqueness of magnets.

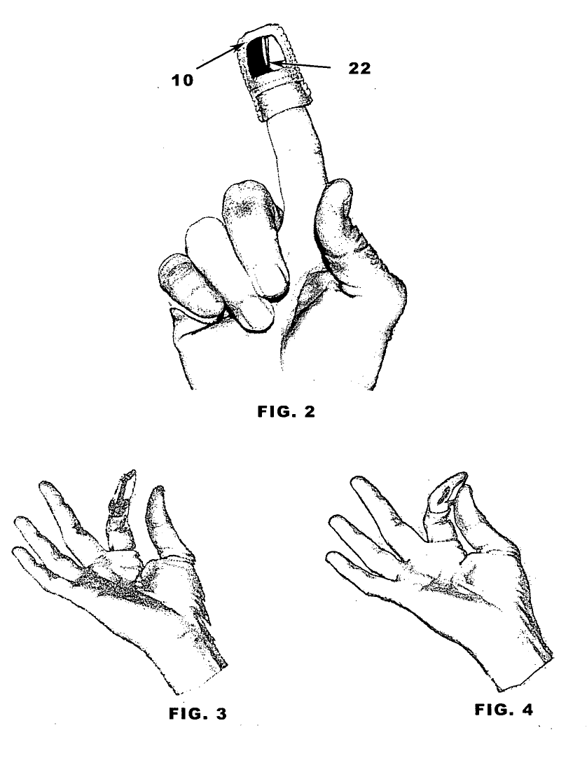

In the drawings, for example, the finger thinking educational tool comprises a finger-tip encirclement 10 to be worn on a finger of a user's hand when writing or studying (FIGS. 2-4). Wearable on one of the index, middle, ring and little fingers of the right hand, (or on the thumb of the right hand), the finger-tip encirclement 10 is composed of a durable soft fabric having front and back surfaces 12, 14, which may be sewn together by stitching 16 along its opposite sides 18, 20. Preferably composed of a flexible fabric, the finger-tip encirclement 10 can then be placed on the selected finger by a pinching of its opposite sides 18, 20. Composed of leather, for instance, it can be placed on the finger in this manner just to provide a comfortable fit, and not necessarily a perfect fit—and in two shades, brown and natural, of a selected size so that it can be stored easily in a pocket, pocketbook, school bag, pencil case, desktop, etc. The finger-tip encirclement 10 in use can be placed over the index finger as in FIGS. 2-4, or on alternative fingers where desired, when learning the educational material to begin with.

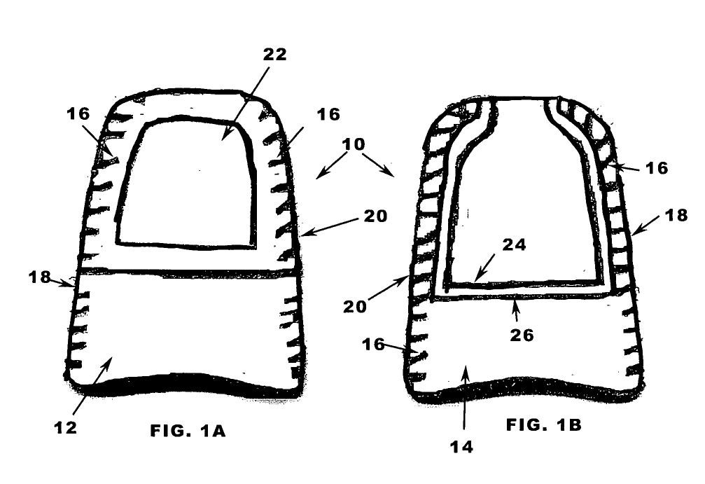

As shown in the drawings, the FINGERTHINKERS educational tool also includes a discernible point of attention focus 22, preferably smooth to a tapping or rotational touch. In the form of a magnetic insert (and one providing a black screen appearance, for example), the insert 22 is positioned to face inwardly towards the palm of the user's hand (FIGS. 2-4), and need be only of minimal strength. As more clearly indicated in FIGS. 1A and 1B, the magnetic insert—or other discernible point of attention focus—is permanently affixed with the finger-tip encirclement 10, as by a sewing with stitches 24, 26.

In use, as when a need presents itself to focus or concentrate on any particular subject such as studying or taking a test, the thumb and index finger as in FIGS. 2-4 are brought together, the magnetic surface 22 is touched with the face of the thumb and then tapped or rotated. Such physical process unconsciously makes one pay more attention in focusing and in recalling the information, providing the same placebo effect one gets through psychological biofeedback in double-blind medication study tests.

In selecting the various components for the finger thinking educational tool of the invention, various criteria come into play: a) the shape of the encirclement 10 recreates considerations of tieing a ribbon around one's finger to stimulate memory recall; b) magnets have been accepted in the population as a potential health aid—just as have been the wearing of copper-type wristbands to ease arthritis; c) magnets are fun items that schoolage children can relate to; and d) a selection of color availabilities for the fabric give children a choice for what they might feel most comfortable with. As to the use of the magnetic surface, biofeedback research indicates that magnets somehow increase blood flow along with a mysterious ability to relieve discomforts throughout the bodY. Although science has not yet explained the positive results that use of magnets seem to claim—perhaps, the increase of blood flow attendant with the “mind over matter” belief stimulates more oxygenated blood flow to the brain in producing these results.

As will be appreciated by those skilled in the art, this finger thinking educational tool of the invention is an “association tool”, which creates a direct connection, both visually and physically, to information stored in one's memory. Complementing biofeedback studies, the finger thinking educational tool uses physical stimulus to assist mental concentration and encourages and fosters cognitive thinking while appealing to a child's sense of curiosity and fun.

Intended as a learning tool to stimulate thinking inside and outside the classroom by natural means, the FINGERTHINKERS educational tool increases learning and memory tasks that takes the student to greater achievement in all subjects. Although its described design is intended to look and feel like a toy (so as to be interesting, especially to a schoolage child), its function is to create a path for memory and learning to occur naturally. Even though a 15-30% positive response with placebo medication is deemed unacceptable when looking for significantly higher medicinal responses, any increase in that proportion in the educational field is acknowledged to be an outstanding achievement, readily obtainable with the stimulated increased learning and memory responses available with the educational tool of the invention. While it is generally accepted that in medicine a placebo is a valuable control mechanism, in education, as with the invention, when it is properly introduced, the use of this FINGERTHINKERS placebo leads to tremendous advances in learning.

In one manner of use, the FINGERTHINKERS tool 10 can be placed on any finger of the hand when learning the material initially, then taken off and stored away, only to be put back in place when trying to recall the material later on. If it is so being utilized when writing, the tool would be preferably placed on a finger of the user's non-dominant hand, leaving the dominant hand to guide the pen or pencil being written with—or to touch a computer keyboard or screen to otherwise input information in retrievable form. In this later respect, FIGS. 2-4 would indicate the use for a left-hand dominant person.

While there have been described what are considered to be preferred embodiments of the present invention, it will be readily appreciated by those skilled in the art that modifications can be made without departing from the scope of the teachings herein. Thus, whereas a preferred embodiment of the finger-thinking educational tool involves a construction where the magnet employed presents a black screen some 2 cm high by 2 cm wide, in an overall top-to-bottom length for the encirclement 10 of 4.5 cm, other dimensions may be selected, especially if a size were selected for wearing by younger, rather than by older school-age children, or by adults for that matter. For at least such reason, therefore, resort should be had to the claims appended hereto for a true understanding of the scope of the invention.

I claim:

1. A finger thinking educational tool comprising a finger-tip encirclement worn on a finger of a user's hand when writing or studying, having a surface positioned thereon to be rubbed between at least two fingers of the hand in recalling educational material previously learned.

2. The finger thinking educational tool of claim 1 wherein said finger-tip encirclement is worn on one of the index, middle, ring and little fingers of the hand.

3. The finger thinking educational tool of claim 1 wherein said finger-tip encirclement is worn on the thumb of the hand.

4. The finger thinking educational tool of claim 1 wherein said finger-tip encirclement is composed of a durable soft fabric.

5. The finger thinking educational tool of claim 1 wherein said finger-tip encirclement is composed of a durable soft flexible fabric placeable on a finger of the hand by a pinching of opposite sides thereof.

6. The finger thinking educational tool of claim 5 wherein said finger-tip encirclement is composed of a leather-like fabric.

7. The finger thinking educational tool of claim 6 wherein said finger-tip encirclement is composed of one of a natural and brown colored leather.

8. The finger thinking educational tool of claim 1 wherein said surface includes a discernible point of attention focus thereon.

9. The finger thinking educational tool of claim 1 wherein said surface includes a discernible point of attention focus smooth to a tapping or rotational touch.

10. The finger thinking educational tool of claim 8 wherein said discernible point of attention focus includes a magnetic insert.

11. The finger thinking educational tool of claim 8 wherein said discernible point of attention focus includes a magnetic insert of small screen appearance.

12. The finger thinking educational tool of claim 10 wherein said discernible point of attention focus includes a magnetic insert of minimal strength.

13. The finger thinking educational tool of claim 10 wherein said discernible point of attention focus includes a magnetic insert of minimal strength facing inwardly towards the palm of the user's hand.

14. A finger thinking educational tool comprising a finger-tip encirclement worn on one of the index, middle, ring and little fingers of a user's hand when writing or studying, having a magnetic surface positioned thereon to be rubbed between the thumb and said one finger of the hand in recalling educational material previously learned.

15. The finger thinking educational tool of claim 14 wherein said finger-tip encirclement is composed of a soft flexible fiber on which said magnetic surface is permanently affixed adjacent the finger-tip thereof, inwardly facing the palm of the user's hand.

16. The finger thinking educational tool of claim 14 wherein said magnetic surface is of a black screen appearance.

17. The finger thinking educational tool of claim 16 wherein said finger-tip encirclement is composed of a leather-like fabric of brown or natural color.

18. A finger thinking educational tool comprising a finger-tip encirclement worn on one of the fingers of a school-age child's hand when writing or studying, having a magnetic surface positioned thereon to be rubbed with the thumb of the hand in recalling educational material previously learned.

19. The finger thinking educational tool of claim 18 wherein said finger-tip encirclement is worn on one of the index, middle, ring and little fingers of a school-age child's non-dominant hand.

20. A finger thinking educational tool of claim 18 wherein said finger-tip encirclement is worn on the thumb of a school-age child's non-dominant hand.
